(19) United States
(12) Patent Application Publication
(10) Pub. No.: US 2015/0127127 A1
(43) Pub. Date: May 7, 2015

(54) APPARATUS, SYSTEM AND METHOD FOR DIGITAL MEDIA COMPETITION

(71) Applicant: Hitfu, Inc., Alpine, UT (US)

(72) Inventors: Ted Elliott Carpenter, Alpine, UT (US); Thad Christopher Smith, Enumclaw, WA (US)

(21) Appl. No.: 14/536,369

(22) Filed: Nov. 7, 2014

Related U.S. Application Data
(60) Provisional application No. 61/901,062, filed on Nov. 7, 2013.

(51) Int. Cl. A63F 13/49; A63F 13/33

(52) U.S. Cl. CPC A63F 13/49; A63F 13/33
USPC 700/92

(57) ABSTRACT

Disclosed herein is a method for managing a web-based digital media competition that includes presenting on graphical user interfaces of a plurality of first computing devices a competition between at least two digital media. The method also includes receiving at a feedback module of a second computing device competition-related input from a plurality of users via the graphical user interfaces, the second computing device being remote from the first computing device. Further, the method includes calculating a winner of the competition based on the competition-related input from the plurality of users. Additionally, the method includes modifying a status of the at least two digital media based on the winner of the competition, and modifying a status of the plurality of users based on the winner of the competition.

### CROSS-REFERENCE TO RELATED APPLICATION

This application claims the benefit of U.S. Provisional Patent Application No. 61/901,062, filed Nov. 7, 2013, which is incorporated herein by reference.

### FIELD

The present application is related generally to a social media network, and more specifically to a web-based digital media competition.

### BACKGROUND

Social media networks include web-based applications that facilitate the creation and exchange of user-generated content by users of the networks. Some users of social media networks generate content, and others of the users of social media networks consume content. Generally, social media networks provide a web-based forum in which users that generate content can exchange user-generated content to users that consume content.

### SUMMARY

The subject matter of the present application has been developed in response to the present state of the art, and in particular, in response to shortcomings of conventional social media networks and associated web-based applications. One such shortcoming includes the difficulty of promoting the exchange of certain types of user-generated content, such as digital media, in an interactive way. The subject matter of the present application has been developed to provide apparatuses, systems, and methods for digital media competition over a social media network that overcome at least some of the above-discussed shortcomings of the prior art.

According to one embodiment, a method for managing a web-based digital media competition includes presenting on graphical user interfaces of a plurality of first computing devices a competition between at least two digital media. The method also includes receiving at a feedback module of a second computing device competition-related input from a plurality of users via the graphical user interfaces, the second computing device being remote from the first computing device. Further, the method includes calculating a winner of the competition based on the competition-related input from the plurality of users. Additionally, the method includes modifying a status of the at least two digital media based on the winner of the competition, and modifying a status of the plurality of users based on the winner of the competition.

According to one implementation, the method further includes uploading to a competition management server the at least two digital media. Modifying the status of the at least two digital media includes modifying a status of an artist of each of the at least two digital media in some implementations of the method. In certain implementations of the method, the competition includes a plurality of battles, where the competition-related input includes winners of each of the plurality of battles as selected by each of the plurality of users.

In some implementations, the method further includes selecting the at least two digital media of the competition. According to one implementation, the at least two digital media are selected based on the status of the at least two digital media. In an implementation, the at least two digital media are selected based on match of at least one characteristic of the at least two digital media. In yet one implementation, the at least two digital media are selected based on a genre of the at least two digital media.

According to certain implementations, the method also includes electronically broadcasting over a communications network data regarding the competition to a social media web client.

In an implementation, the method includes selecting the plurality of users for participation in the competition based on user-defined judging preferences of the plurality of users.

According to some implementations, the method includes presenting on graphical user interfaces of a plurality of first computing devices a plurality of competitions between at least two digital media. The at least two digital media include a first digital media. The quantity of the plurality of competitions is based on the status of the first digital media. The quantity of the plurality of competitions can be lower if the status of the first digital media is below a threshold than if the status of the first digital media is above the threshold.

In some implementations, the competition-related input includes quality metrics. The method may include modifying the status of the at least two digital media based on the quality metrics.

In certain implementations, the competition includes a plurality of battles. The competition-related input includes winners of each of the plurality of battles as selected by each of the plurality of users. Modifying the status of the plurality of users is based on whether the plurality of users selected the winner of the competition.

According to another embodiment, an apparatus for managing a web-based digital media competition includes a media indexing module that is configured to receive and categorize a plurality of artist media uploads created by a plurality of artists. The apparatus also includes a media selection module that is configured to select at least two of the plurality of artist media uploads based on the categorization of the plurality of artist media uploads. Further, the apparatus includes an event control module that is configured to present a web-based competition between the at least two of the plurality of artist media uploads. Also, the apparatus includes a judge indexing module that is configured to categorize a plurality of judges and to select at least a portion of the plurality of judges to judge the web-based competition.

In some implementations, the apparatus further includes a networking module that is configured to notify users of social media websites linked to the artists of the two artist media uploads and the selected portion of the plurality of judges regarding information about the web-based competition.

According to certain implementations of the apparatus, the artist media uploads each includes a music track. The event control module can include a digital music player that is configured to play the music tracks.

According to yet certain implementations of the apparatus, each of the artist media uploads is assigned a first status, and each of the plurality of judges is assigned a second status. The first status of an artist media upload is based on a result of at least one web-based competition between the artist media upload an another artist media upload, and the second status of a judge is based on a result of at least one web-based competition judged by the judge.

In another embodiment, a system for managing a web-based digital media competition includes an electronic communications network and a competition management server. The competition management server includes a competition management apparatus that is configured to process information regarding digital music tracks, determine appropriate digital music track matches for web-based competitions, execute web-based competitions between matched digital music tracks and judged by judges over the electronic communications network, and update statuses of the digital music tracks and judges based on results of the web-based competitions. The system also includes an artist client that is accessible by an artist to upload digital music tracks to the competition management server over the electronic communications network. Further, the system includes a judge client that is accessible by a judge to judge at least one of the web-based competitions.

According to some implementations, the system also includes a sponsor client that is accessible by a sponsor of a web-based competition to access a sponsor account on the competition management server. The system may include a social media web client that is accessible by the competition management server to broadcast information regarding at least one of the web-based competitions via at least one social media networking platform in certain implementations.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter of the present application will be readily understood, a description will be rendered by reference to specific embodiments that are illustrated in the appended drawings. Understanding that these drawings depict only typical embodiments of the subject matter and are not therefore to be considered to be limiting of its scope, the subject matter will be described and explained through the use of the accompanying drawings, in which:

FIG. 1 is a schematic block diagram illustrating one embodiment of a system for digital media competition in accordance with the present subject matter;

FIG. 2 is a detailed schematic block diagram illustrating and embodiment of a competition management apparatus of a system for digital media competition in accordance with the present subject matter;

FIG. 3 is a schematic block diagram illustrating one embodiment of an battle interface of a system for digital media competition in accordance with the present subject matter; and

FIG. 4 is a schematic flow chart diagram of one embodiment of a method for managing, executing, or implementing a digital media competition according to one embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

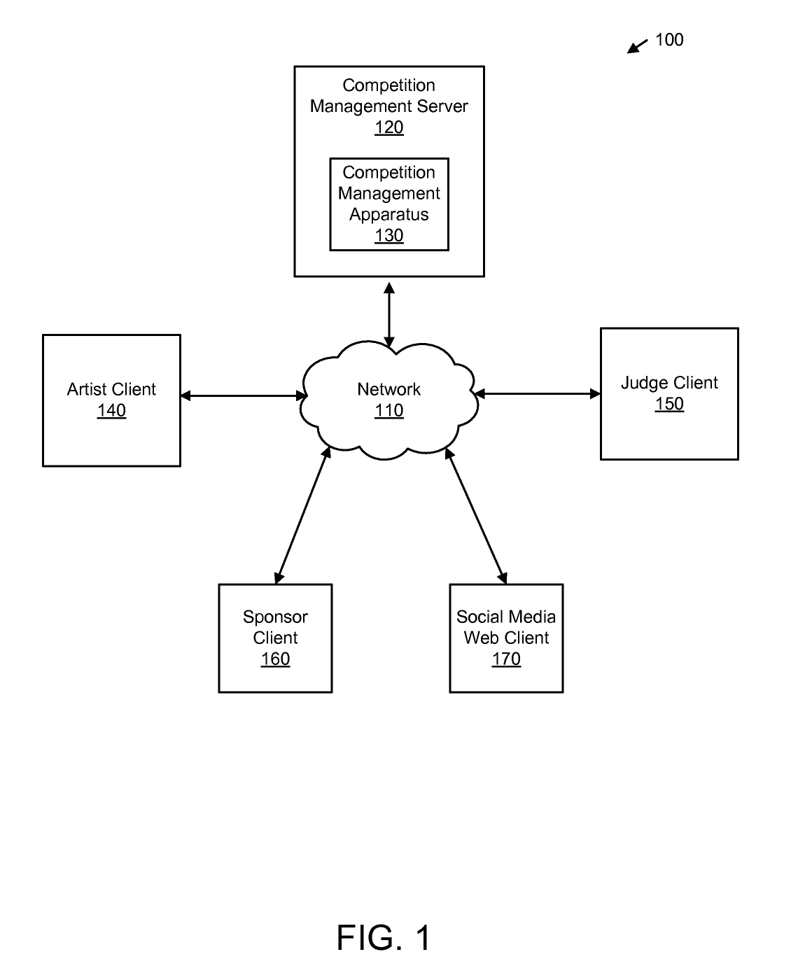

FIG. 1 depicts one embodiment of a system 100 for digital media competition. The system 100 includes a network 110, a competition management server 120, an artist client 140, a judge client 150, a sponsor client 160, and a social media web client 170. The system 100 facilitates a user-judged competition between artist-generated digital media and provides a rewards program for user-judges and artists.

New and emerging artists that generate digital media, such as songs and videos, often find it difficult to promote and market the media they produce. Generally, the primary goal of new and emerging artists is to increase the exposure of their digital media to the public. Public exposure commonly leads to popularity, which provides artists with a base support system from which their talents may be monetized. Accordingly, one significant challenge for artists is to not only produce quality and appealing audio or video tracks, but also to find an accessible platform that positively exposes their talents and promotes their success. Additionally, users of digital media (e.g., listeners of music and watchers of video) often seek opportunities to experience and support new digital media, while actively participating in the process. According to some embodiments, described herein is a system for digital media competition that provides artists with an effective venue for publically exposing their digital media and opportunities to be directly rewarded for producing appealing media, as well as provides users with an opportunity to experience and judge new digital media, and be directly rewarded for their participation.

The competition management server 120 includes a competition management apparatus 130 that conducts digital media competitions (each with a plurality of individually judged battles), analyzes judging input from the battles of the competition, and broadcasts competition information to third-party social media networks via a competition management platform. In certain implementations, the competition management server 120 communicates with various clients over a network 110. The competition management server 120 may be a server provided for a competition management entity. The competition management entity may be an organization that provides, owns, and/or manages the competition management apparatus 120 as described below. The competition management server 120 may include memory, a storage device storing computer readable programs, and a processor that executes the computer readable programs as is known to those skilled in the art. In one embodiment, the competition management apparatus 130 is a computer readable program executed on the competition management server 120.

The competition management platform refers to logic, software code, and the like to manage digital media competitions with artists, judges, sponsors, and social media networks as described herein. The competition management platform may be embodied by a competition management website accessible by a web browser. In one embodiment, the competition management platform may be accessible by mobile devices through applications executing on the mobile devices. The competition management website provided by the competition management platform may be embodied as one or more web pages available for access over the network 110. Each web page may include software code, images, and text as is known in the art. Specifically, each web page may include static and/or dynamic elements and include Hypertext Markup Language (“HTML”) code, JavaScript code, Flash animations, and the like. The competition management platform is provided by the competition management apparatus 130 and hosted on one or more competition management servers 120, as depicted. In other embodiments, the competition management apparatus 130 may exist as a plug-in or be otherwise integrated with an existing social media networking or other website.

The network 110 may be embodied as a global communications network such as the Internet, a Local Area Network (“LAN”), multiple LANs communicating over the internet, a Wireless Local Area Network (“WLAN”), a mobile telecommunications network such as a 3G or 4G network, or any other suitable communications network.

Each of the artist client 140, judge client 150, sponsor client 160, and social media web client 170 may communicate with the competition management server 120 through the network 110. Moreover, each of the clients 140, 150, 160, 170 may be embodied as computing devices having memory, a storage device storing computer readable programs, and a processor that executes the computer readable programs as is known to those skilled in the art. In some implementations, each of the clients 140, 150, 160, 170 may be a personal desktop assistant (“PDA”), a tablet computer, a slate computer, an e-Book reader, a mobile computing device, a smartphone, a desktop computer, a portable computer, a laptop computer, a server, a mainframe computer, or the like. Moreover, each client may include competition management platform access tools, such as web browsers, web applications, and the like, that allow users access to the platform.

The artist client 140 is accessible by an artist to upload digital media to the competition management server 120 over the network 110. Although digital media can be defined as any of various forms of digital media exhibiting some artistic expression, such as music, video works, literary works, sound recordings, industrial designs, graphical artwork, and the like, in the following description, digital media in the form of music songs or tracks will be referenced. It is noted that any reference to music songs or tracks can be replaced with another form of digital media without departing from the essence of the present disclosure. Additionally, the artist may use the artist client 140 to access an artist account stored on the competition management server 120. The artist can access his/her artist account for various reasons, such as to track the progress of an uploaded music track, access interactive content on the competition management server 120, communicate with others via social media platforms, enter and modify account preferences or settings, and the like. The artist client 140 may include a web-based portal through which the artist can log into the artist account on the competition management server 120.

Initially, along with creating an artist account on the competition management server 120, a new artist uploads one or more music tracks in the form of a digital file to the competition management server 120. As part of the intake process for a new music track upload, the competition management server 120 may request, and the new artist may enter, information regarding the artist and the music track. As will be described in more detail below, the competition management apparatus 130 processes the newly uploaded music track, determines an appropriate music track match for a competition, executes a competition between the new music track and music track match that can be judged over the network 110 by user-judges via judge clients 150, and updates the status of the new music track based on the results of the competition.

The judge client 150 is accessible by a user to judge music track competitions generated by the competition management apparatus 130. As defined herein a user-judge is a user who judges or intends to judge music track battles of music track competitions generated by the competition management apparatus 130. Additionally, the user-judge may use the judge client 150 to access a judge account stored on the competition management server 120. The user-judge can access his/her judge account for various reasons, such as to track his/her progress and success as a judge of battles, track the status of competitions the user has judged, access interactive content on the competition management server 120, communicate with others via social media platforms, enter and modify account preferences or settings, and the like. The judge client 150 may include a web-based portal through which the user-judge can log into the judge account on the competition management server 120.

Along with creating a judge account on the competition management server 120, a new user-judge elects to participate as a judge in battles of competitions between two music tracks based on the preferences of the user-judge. As part of the intake process for a new user-judge, the competition management server 120 may request, and the new user-judge may enter, information regarding the judging preferences of the user-judge, such as music genre preferences. As will be described in more detail below, the competition management apparatus 130 processes the preferences of the new user-judge, determines an appropriate music track competition based on the preferences, enters the user-judge as a judge for a battle in the competition, and updates the status of the user-judge based on the user-judge's selection of the winner of the battle in view of the winner of the competition.

The sponsor client 160 of the system 100 is accessible by a sponsor of the music track competitions organized by the competition management entity. The sponsor may use the sponsor client 160 to access a sponsor account on the competition management server 120. The sponsor can access its sponsor account for various reasons, such as to update sponsorship information, donate cash and prizes for organizing the music track competitions and for competition winners, set or modify account settings, and the like. Artists and/or user-judges may also access the sponsor client 160 via the network 110 and competition management server 120 to redeem virtual/real currency or credits (e.g., obtained through participation in the music track competitions) for products or services of the sponsor.

The social media web client 170 is accessible by the competition management server 120 to advertise, market, and transmit music track competitions and related information to any of various social media communities or social media networking platforms, such as Twitter®, Facebook®, YouTube®, and the like. Additionally, in some implementations, artists and user-judges may access the social media web client 170 either directly via the artist and judge client, 140, 150, respectively, or indirectly via the competition management server 120.

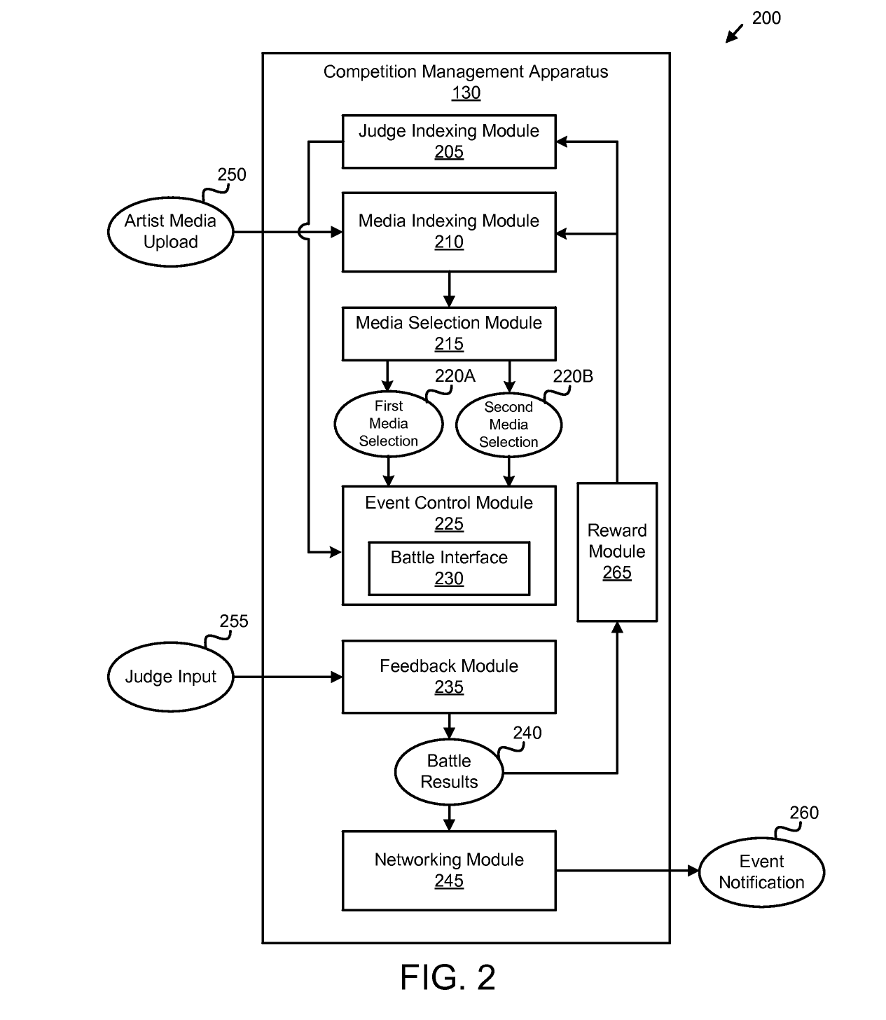

Referring to FIG. 2, and according to one embodiment, the competition management apparatus 130 includes a judge indexing module 205, a media indexing module 210, a media selection module 215, an event control module 225, a feedback module 235, and a networking module 245. Generally, the competition management apparatus 130 receives artist media uploads 250, executes music track competitions, receives judge input 255 from judges judging battles of the competitions, sends competition event notifications 260 to social media network platforms, and updates the status of artists, judges, and judged music tracks according to competition results.

The judge indexing module 205 categorizes user-judges according to any of various factors associated with the user-judges preferences and characteristics, such as, for example, genre preferences, interests, hobbies, age, sex, residence, and the like. Additionally, the judge indexing module 205 may group together user-judges with similar preferences and characteristics.

The media indexing module 210 receives artist media uploads 250 from new and existing artists. As mentioned above, the artist media uploads 250 can be music tracks. Along with the uploads 250, the media indexing module 210 receives information regarding the genre or type of the music from the artist. The media indexing module 210 may include memory for storing the music track uploads 250 and associated data identifying and categorizing the music tracks.

Additionally, the media indexing module 210 is configured to update a status of uploaded music tracks based on results of competition events in which the music tracks have participated. The status can include various levels or ranks based on any of various factors relating to the competition events, such as the number of competitions won (e.g., the appeal or popularity of the tracks), quality metrics or ratings assigned to the music tracks by judges, and the like. Generally, the status of a music track is linked to the frequency of future competitions featuring the music track. Accordingly, the higher or more prestigious the status, the more competitions featuring the music track and the higher the overall exposure to the music track. In contrast, the lower or less prestigious the status, the fewer the number of competitions featuring the music track and the lower the overall exposure to the music track.

The status may be an overall quality score. The media indexing module 210 may assign and update an overall quality score for each music track based on user-judges ratings and winner selections over a predetermined number of competition battles. Should the overall quality score for a music track drop below a threshold, the music track may appear in fewer competition events, or if it drops low enough, be banned from appearing in future competition events. Artists may have the ability to increase the overall quality score of a music track through one or more actions, such as paying an upgrade fee.

The media selection module 215 is configured to select at least two music tracks (e.g., first media selection 220A and second media selection 220B) to compete against each other in a public or private competition. The media selection process executed by the media selection module 215 includes following certain criteria for pairing two music tracks against each other. In one implementation, the criteria are based on the genre and status of the selected music tracks. For example, the media selection module 215 may select only music tracks from the same or similar genre, and only music tracks having the same or similar status. Further, according to some implementations, the media selection module 215 selects music tracks with a higher status for competitions more often than music tracks with a lower status. In other words, music tracks with a higher status are given priority over music tracks with a lower status. In certain implementations, the media selection module 215 selects the two music tracks based on at least one of genre, status, ratings and battles won within a specific genre, overall ratings, and overall quality score. According to one implementations, the media selection module 215 selects the two music tracks based on a preferential process with the genre being considered first, the ratings and battles won within a specific genre next, then the overall ratings, and finally the overall quality score. Although the media selection module 215 selects only two music tracks for a head-to-head competition, in some implementations, the media selection module can select more than two music tracks for a competition if desired.

The event control module 225 is configured to execute a competition event or a competition that includes a plurality of individually-judged battles between the music tracks selected by the media selection module 215 with each battle being judged by a user-judge selected from the judge indexing module 205.

In one embodiment, the competition event is a bracket-style tournament or contest that begins with a plurality of music tracks and ends with a single winner. The event control module 225 is configured to organize the bracket-style tournament by creating multiple battles each including two music tracks competing against each other. The winner of each battle advances to compete against another battle winner, until a single undefeated music track remains. In some implementations, the bracket-style tournament is a general-purpose tournament designed to determine a general winner. In other implementations, the bracket-style tournament is a specific-purpose tournament designed to determine a winner of a sponsored contest. For example, a sponsor may utilize the competition management server 120 to conduct a bracket-style tournament sponsored by the sponsor. In an implementation, the sponsor may elect to have the artist of the winner of the bracket-style tournament conducted by the competition management server 120 compete against one or more other artists in live setting to determine an ultimate winner.

The user-judges selected from or assigned by the judge indexing module 205 are selected or assigned based on the preferences of the user-judges in view of the characteristics of the music tracks competing against each other. For example, the judge indexing module 205 may ensure that user-judges interested in music of a particular genre are assigned to judge only those competitions with music tracks of that or similar genre. As another example, the judge indexing module 205 may ensure that user-judges of a certain age are assigned to judge only those competitions with music tracks traditionally associated with that age. Of course, many factors and preferences of user-judges can be taken into consideration when assigning user-judges to specific competitions to increase the probability that the user-judges are satisfied with and interested in the music tracks forming the basis for the competition.

To facilitate the execution of the competition event, the event control module 225 generates a battle interface 230 accessible to, among others, user-judges assigned to judge the battles of the competition between music tracks. The battle interface 230 can be a graphical user interface in the form of a web-based application on a website that is viewable and accessible from the judge client 150. Further, the battle interface 230 includes functionality that allows a user-judge to listen to music tracks and enter input (e.g., scores, winning music track, ratings, etc.). In one implementation, the visual representation of the battle interface 230 may be controlled or designed by a sponsor.

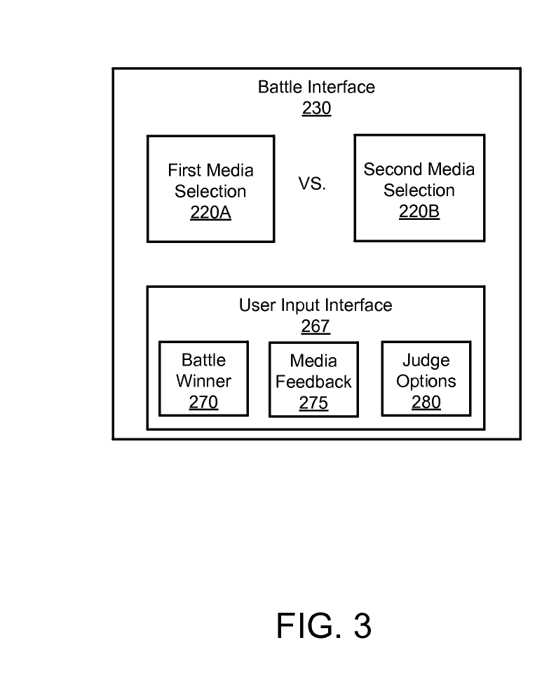

Referring to FIG. 3, and according to one embodiment, the battle interface 230 includes graphical representations of the first and second media selections 220A, 220B that are competing in a current competition. The battle interface 230 may include indicia, such as “vs.” suggesting the first and second media selections 220A, 220B are in competition with each other. Whether part of, or separate from, the graphical representations of the first and second media selections 220A, 220B, the battle interface 230 includes a playback feature (e.g., in the form of a digital media player) that is selectable by a user-judge to play, and give the user-judge an opportunity to listen to, each of the first and second media selections.

The battle interface 230 also includes a user input interface 267 configured to receive user input from a user-judge judging the current competition. The user input interface 267 includes input features for a battle winner 270, media feedback 275, and judge options 280. As defined herein, a music track competition event includes multiple battles each individually judged by a separate user-judge. Accordingly, each battle of a competition has a winner selected by a unique user-judge, and each competition has a winner based on the accumulation of the winners of the individual battles of that competition. Once a competition event between two music tracks is generated by the event control module 225, multiple user-judges individually and separately access a battle interface 230 to input their selections for a respective one of multiple battles defining the competition event.

The battle winner 270 feature receives the selection of the winner of a battle from a user-judge. In some implementations, the battle interface 230 requires a user-judge to listen to an entirety of the first and second media selections 220A, 220B in order to select a battle winner 270.

The media feedback 275 feature receives feedback from a user-judge regarding various metrics or ratings of one or both of the first and second media selections 220A, 220B. In one implementation, the metrics include various levels (e.g., from high to low) of one or more of originality, performance, quality, entertainment value, and hit probability. The user input interface 267 may require a user-judge to enter feedback for one or both of the media selections using the media feedback 275 feature before the user-judge will get credit for judging a battle.

The judge options 280 feature can include any of various actions and/or preferences selectable by a user-judge to enhance the pre-judging or post-judging experiences of the user-judge. For example, in one implementation, the judge options 280 include an option to purchase one or both of the first and second media selections 220A, 220B via a point-of-sale tool. In certain implementations, the judge options 280 include an option to tag one or both of the first and second media selections 220A, 220B as a favorite to be added to a favorites list maintained by the competition management server 120. Because encountering a media selection from one competition event in a future competition event may occur only infrequently, such a favorites list allows a user-judge to access a selection outside of (e.g., after) a competition event at the user-judge's discretion. A user-judge may then have the ability to access the media selections in his/her favorites list in various ways. For example, a user-judge can stream a music track from his/her favorites list a limited or unlimited number of times. For limited use streaming, a user-judge can purchase more streams of a track if desired, or alternatively, the user-judge can purchase the track for download.

According to yet some implementations, the judge options 280 include an option to notify (e.g., share with) others, such as friends on social media networking websites, of information regarding the current competition, such as the existence of the current competition, the judging of a battle of the competition by the user-judge, the artists of the media selections competing in the current competition, and the like. In yet certain implementations, the judge options 280 may include the ability to ban one or both of the music tracks in a given battle from appearing in a future battle for that user-judge.

Referring back to FIG. 2, the feedback module 235 of the competition management apparatus 130 is configured to receive judge input 255 elicited by the user input interface 267 of the battle interface 230. In other words, the input 255 received by the user input interface 267 is communicated via the network 110 to the feedback module 235, which processes the input and generates battle results 240 representing the outcome of an individual music track battle. The battle results 240 include any of various characteristics of a completed music track battle. For example, the battle results 240 may include the winner of the battle as selected by the user-judge and the metrics or ratings of the competing music tracks as selected by the user-judge.

In some implementations, the competition management apparatus 130 includes a rewards module 265 that receives the battle results 240 from the feedback module 235. According to some implementations, the rewards module 265 credits the accounts of the artists with music tracks participating in a competition event, and credits the accounts of the user-judges who judge the battles of the competition event. More specifically, in certain implementations, the rewards module 265 can be configured to only credit (or more generously credit) the account of an artist of a competition winning music track with rewards and/or only credit (or more generously credit) the account of a user-judge who, in an individual battle, selected the ultimate winner of a completion event. In this manner, artists of the most popular (e.g., most competition winning) music tracks and user-judges more prone to selecting hit-worthy or high-potential music tracks correspondingly receive greater rewards. Accordingly, artists are incentivized to submit high-quality music tracks and user-judges are incentivized to provide thoughtful and meaningful feedback. Rewards can be in the form of real or virtual currency or credits, and can be applied in any of various ways, such as for merchandise or services provided by sponsors.

The battle results 240 also are provided to the judge indexing module 205 of the competition management apparatus 130. The judge indexing module 205 is configured to update the status of user-judges based on the battle results 240. Generally, in some implementations, the status of user-judges is determined based on a comparison to the selections of other user-judges. The status can include levels or ranks based on any of various factors relating to the judging of battles, such as the success or failure of a user-judge to select the ultimate winner of a competition event, the number of battles judged, the level of feedback, when the judge selected the winner of a music track battle and the popularity of the music track at that point in time, and the like. The status of the user-judge may have an impact on which competitions the user-judge is assigned to judge. In certain implementations, the judge indexing module 205 is configured to increase the status of those user-judges that exhibit an ability to identify music tracks that have a high potential to be a popular music track.

In some implementations, user-judges meeting a predetermined threshold status (e.g., high-level user-judges), or other non-user-judges (e.g., professional reviewers, employees, etc.), may participate in the media intake process by vetting non-trusted new artist media uploads 250 to ensure the uploads meet minimum standards necessary for competing in the competition events. Should the high-level user-judges determine that a new non-trusted artist media upload 250 does not meet the minimum standards, the media indexing module 210 will index the upload accordingly, and the media selection module 215 will not select the upload for competition. According to certain implementations, a new artist media upload 150 is considered a non-trusted upload when the artist of the upload is new or the artist was previously trusted but has lost its trusted status.

The networking module 245 of the competition management apparatus 130 is configured to broadcast event notifications 260 with information regarding a competition event, such as the results of a competition event or individual battle, to one or more social media networking platforms. The generation of event notifications 260 and the information included therein, can be based on preferences of the competition management entity based on relationships with the social media networking platforms and/or preferences of the user-judges. Generally, the event notifications 260 are designed to notify users on social media networking platforms of competition events taking place on the competition management website. In some implementations, event notifications 260 are sent to each user of a social media networking platform that is grouped in the same network as, or otherwise linked to (e.g., friends of) a user-judge or artist of a music track participating in a battle. The event notifications 260 may encourage those users linked to the user-judge and artists to perform certain actions, such as follow the completion event, support the user-judge or artist in a battle, become a user-judge in the current competition or future competitions, follow or listen to one or more of the artists or music tracks in the competition. In this manner, the exposure and reach of the artists and associated music tracks, as well as the services provided by the competition management entity, expands quickly and effectively.

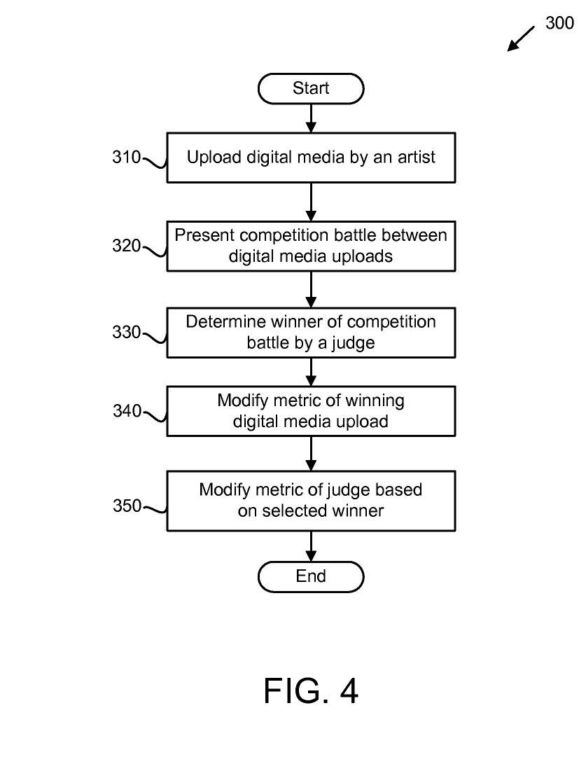

Referring to FIG. 4, according to one embodiment, a method 300 for managing a web-based digital media competition includes uploading digital media by an artist at 310. The digital media can be music tracks uploaded by a plurality of artists into a database of uploaded music tracks. The method 300 also includes presenting competition battles between digital media uploads to judges at 320. Additionally, the method 300 includes determining winners of the competition battles by the judges at 330. The competition battles are part of a competition event between two digital media uploads. In one implementation, the results or winners of the individual competition battles are tallied and an overall winner of the competition event is determined based on the digital media upload with the most battle wins. The method 300 may present and have judged a predetermined number of battles (e.g., 1,000) before determining at overall winner of the competition event. The method 300 may include modifying a metric of the winning digital media upload at 340 and modifying a metric of the judge based on the judge's selection of the winner of the competition battle at 350. Modifying the metric of the winning digital media upload may include increasing or upgrading the status of the digital media upload, and presenting the digital media upload in competition events at a higher frequency. In some implementations, losing digital media uploads may also experience an increase in status should the number of winning battles exceed a threshold or the quality metrics selected by the judges for the losing digital media exceed upper thresholds. The method 300 may also include decreasing or downgrading the status of a losing digital media upload, such as when a threshold number of battles won is below a threshold, or quality metrics selected by the judges do not meet lower thresholds.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method for managing a web-based digital media competition, comprising:
presenting on graphical user interfaces of a plurality of first computing devices a competition between at least two digital media;
receiving at a feedback module of a second computing device competition-related input from a plurality of users via the graphical user interfaces, the second computing device being remote from the first computing device;
calculating a winner of the competition based on the competition-related input from the plurality of users;
modifying a status of the at least two digital media based on the winner of the competition; and
modifying a status of the plurality of users based on the winner of the competition.

2. The method of claim 1, further comprising uploading to a competition management server the at least two digital media.

3. The method of claim 1, wherein modifying the status of the at least two digital media comprises modifying a status of an artist of each of the at least two digital media.

4. The method of claim 1, wherein the competition comprises a plurality of battles, and wherein the competition-related input comprises winners of each of the plurality of battles as selected by each of the plurality of users.

5. The method of claim 1, further comprising selecting the at least two digital media of the competition, and wherein the at least two digital media are selected based on the status of the at least two digital media.

6. The method of claim 1, further comprising selecting the at least two digital media of the competition, and wherein the at least two digital media are selected based on match of at least one characteristic of the at least two digital media.

7. The method of claim 1, further comprising selecting the at least two digital media of the competition, and wherein the at least two digital media are selected based on a genre of the at least two digital media.

8. The method of claim 1, further comprising electronically broadcasting over a communications network data regarding the competition to a social media web client.

9. The method of claim 1, further comprising selecting the plurality of users for participation in the competition based on user-defined judging preferences of the plurality of users.

10. The method of claim 1, wherein the method comprises presenting on graphical user interfaces of a plurality of first computing devices a plurality of competitions between at least two digital media, the at least two digital media comprising a first digital media, and wherein the quantity of the plurality of competitions is based on the status of the first digital media.

11. The method of claim 10, wherein the quantity of the plurality of competitions is lower if the status of the first digital media is below a threshold than if the status of the first digital media is above the threshold.

12. The method of claim 1, wherein the competition-related input comprises quality metrics, and wherein the method comprises modifying the status of the at least two digital media based on the quality metrics.

13. The method of claim 1, wherein the competition comprises a plurality of battles, the competition-related input comprising winners of each of the plurality of battles as selected by each of the plurality of users, and wherein modifying the status of the plurality of users is based on whether the plurality of users selected the winner of the competition.

14. An apparatus for managing a web-based digital media competition, comprising:
a media indexing module configured to receive and categorize a plurality of artist media uploads created by a plurality of artists;
a media selection module configured to select at least two of the plurality of artist media uploads based on the categorization of the plurality of artist media uploads;
an event control module configured to present a web-based competition between the at least two of the plurality of artist media uploads; and
a judge indexing module configured to categorize a plurality of judges and to select at least a portion of the plurality of judges to judge the web-based competition.

15. The apparatus of claim 14, further comprising a networking module configured to notify users of social media websites linked to the artists of the two artist media uploads and the selected portion of the plurality of judges regarding information about the web-based competition.

16. The apparatus of claim 14, wherein the artist media uploads each comprises a music track, and wherein the event control module comprises a digital music player configured to play the music tracks.

17. The apparatus of claim 14, wherein each of the artist media uploads is assigned a first status, and each of the plurality of judges is assigned a second status, and wherein the first status of an artist media upload is based on a result of at least one web-based competition between the artist media upload an another artist media upload, and the second status of a judge is based on a result of at least one web-based competition judged by the judge.

18. A system for managing a web-based digital media competition, comprising:
an electronic communications network;
a competition management server comprising a competition management apparatus configured to process information regarding digital music tracks, determine appropriate digital music track matches for web-based competitions, execute web-based competitions between matched digital music tracks and judged by judges over the electronic communications network, and update statuses of the digital music tracks and judges based on results of the web-based competitions;
an artist client accessible by an artist to upload digital music tracks to the competition management server over the electronic communications network; and
a judge client accessible by a judge to judge at least one of the web-based competitions.

19. The system of claim 18, further comprising a sponsor client accessible by a sponsor of a web-based competition to access a sponsor account on the competition management server.

20. The system of claim 18, further comprising a social media web client accessible by the competition management server to broadcast information regarding at least one of the web-based competitions via at least one social media networking platform.
